(19) United States
(12) Patent Application Publication
(10) Pub. No.: US 2017/0219915 A1
(43) Pub. Date: Aug. 3, 2017

(54) WHITE FLASH GENERATION FROM A LIGHT EMITTING DIODE (LED) PROJECTOR

(71) Applicant: Hewlett-Packard Development Company, L.P., Houston, TX (US)

(72) Inventors: Robert L Mueller, San Diego, CA (US); Ivan Dejesus Chousal, Chula Vista, CA (US); Ben Wynne, San Diego, CA (US)

(21) Appl. No.: 15/500,652

(22) PCT Filed: Jul. 31, 2014
(86) PCT No.: PCT/US2014/049172

§ 371 Date: Jan. 31, 2017

(51) Int. Cl. G03B 15/05; F21V 33/00; G03B 21/20; F21V 23/04

(52) U.S. Cl. CPC G03B 15/05; F21V 23/0407; F21V 33/0052; G03B 21/2033; G03B 21/2013; F21Y 2115/10

(57) ABSTRACT

A method for generating white flash from a Light Emitting Diode (LED) projector coupled to a computing system is described. The method includes receiving an input to switch projection mode of the LED projector to a white-light mode of projection, where the input is one of a direct user input and an indirect input. The method also includes switching the LED projector to the white-light mode of projection from a first projection mode based on the received input; and actuating, simultaneously, all LEDs of the LED projector to generate a white flash of light in the white-light mode of projection.

### BACKGROUND

Illumination systems are used in different applications, including projection display systems, backlights for liquid crystal displays and the like. Projection systems generally use one or more known white light sources, such as high pressure mercury lamps. A white light beam emitted by the white light sources is usually split into three primary color beams, red, green, and blue, and is directed to respective image forming spatial light modulators to produce an image for each primary color. The resulting primary-color image beams are combined and projected onto a projection screen for viewing. More recently, light emitting diodes (LEDs) have been increasingly used as an alternative to the white light sources.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1(a) illustrates a perspective view of an example projection system, including a LED projector, according to an example of the present subject matter;

FIG. 1(b) illustrates another perspective view of the example projection system including the LED projector according to an example of the present subject matter;

FIG. 2 illustrates an example schematic view of components of an LED projector, according to an example of the present subject matter;

FIG. 3 graphically illustrates operation of the LED projector for generation of white Flash, according to an example of the present subject matter; and

FIG. 4 illustrates a method for generating white flash from the LED projector, according to an example of the present subject matter.

### DETAILED DESCRIPTION

The present subject matter relates to systems and methods for generation of white flash from a Light Emitting Diode (LED) projector. In general, LED projectors employ a red LED, a green LED, and a blue LED to generate light. However, when the LEDs are driven for a long time, temperatures of the LEDs increase, which causes a reduction in levels of lights emitted from the LEDs. Therefore, the LEDs are generally driven in a sequential pattern such that the intensity of light is not affected and the temperature of the LEDs can also be controlled.

With the advent of technology, LED projectors now being developed are relatively compact and can provide power efficient projection engines which can be easily integrated with computing systems like an all-in-one computer. In some situations, the LED projectors associated with the computing systems may also be used as an illumination source while capturing images or making videos. For example, to capture an image from a web camera of an all-in-one computer, the LED projector associated with the all-in-one computer may be utilized as an illuminating source. More often than not, the use of the LED projector as the illuminating source causes a rainbow or gray scale beating artifact to be introduced into the images and the videos. The introduction of such artifacts into the images and videos can generally be attributed to the sequential lighting of different red, green, and blue colored LEDs in the LED projectors.

According to an example of the present subject matter, systems and methods for generation of white flash from a LED projector are described. The described systems and methods, on one hand, may eliminate any introduction of rainbow or gray scale artifacts in images and videos captured by an image capturing device while utilizing the LED projector as an illumination source; on the other, may provide cost effective ways of generating white flash through the existing LED projector.

The described systems and methods may be implemented in various LED projectors coupled with computing systems. Such arrangements where the LED projectors are coupled with computing systems have been described as projection systems, hereinafter. Also, the term “couple”, “couples”, or “coupled” is intended to mean either an indirect or direct connection. Thus, if a first device couples to a second device, that connection may be through a direct electrical or mechanical connection, through an indirect electrical or mechanical connection via other devices and connections, through an optical electrical connection, or through a wireless electrical connection. Various implementations of the present subject matter have been described below by referring to several examples.

In an example of the present subject matter, a LED projector coupled with a computing system may generate white flash, such as that of a flashlight, to avoid introduction of any gray scale or rainbow artifact into an image or video. The LED projector associated with the computing system may either be an integrated LED projector, or may be an external LED projector, capable of being couple with the computing system.

In operation, the LED projector of the present subject matter may operate in one or more projection modes. A projection mode may be understood as a configuration of the LED projector used for projection of data. From amongst the one or more projection modes, in one of the projection modes, the LED projector may generate the white flash. For the sake of explanation, the projection mode in which the LED projector may generate the white flash is referred to as white-light mode, hereinafter.

In one example of the present subject matter, the LED projector may receive an input, such as from the computing system to which the LED projector is coupled to, or from a user, to switch from one of the projection modes to the white-light mode. In one example, the input received by the computing system may also be based on a trigger received from a user, such as a press of a button or a gesture by the user. For the sake of explanation, it may be considered that the LED projector to be operating on a first projection mode. In said example, the LED projector may switch from the first projection mode to the white-light projection mode.

In the white-light mode, the LED projector may generate instantaneous white flash, such that of a flashlight based on actuation of all the LEDs of the LED projector. In other words, the LEDs of the LED projector may not be operated in a sequential manner and may be simultaneously actuated to produce white flash. The simultaneous actuation of the LEDs may generate instantaneous white flash which may not cause any gray scale or rainbow artifact in images and videos being captured by the image capturing device.

In one example, the white flash thus generated in the white-light mode, may generate an increased illuminance, such as about 50% higher or about 80% higher, than the usual illuminance generated by the LED projector. The increase in illuminance during the white-light mode may further assist the image capturing device in capturing better images with increased visibility and better light exposure.

In the white-light mode, the LED projector may generate the white flash for a predetermined time period. In one example, the LED projector may also generate strobes of white flash during the white-light mode. The duration of strobes and the pattern of strobes may be configured based on predefined strobe parameters. Therefore, the LED projector, in the white-light mode, may generate instantaneous white flash for illumination of objects and articles. This may allow eliminate possibilities of occurrence of rainbow or gray scale artifacts while capturing image data of the objects and articles illuminated by the LED projector. The implementation of the described techniques may also eliminate use of an external flashlight which may be expensive and cause hassle while integrating with either the computing system, or the image capturing device.

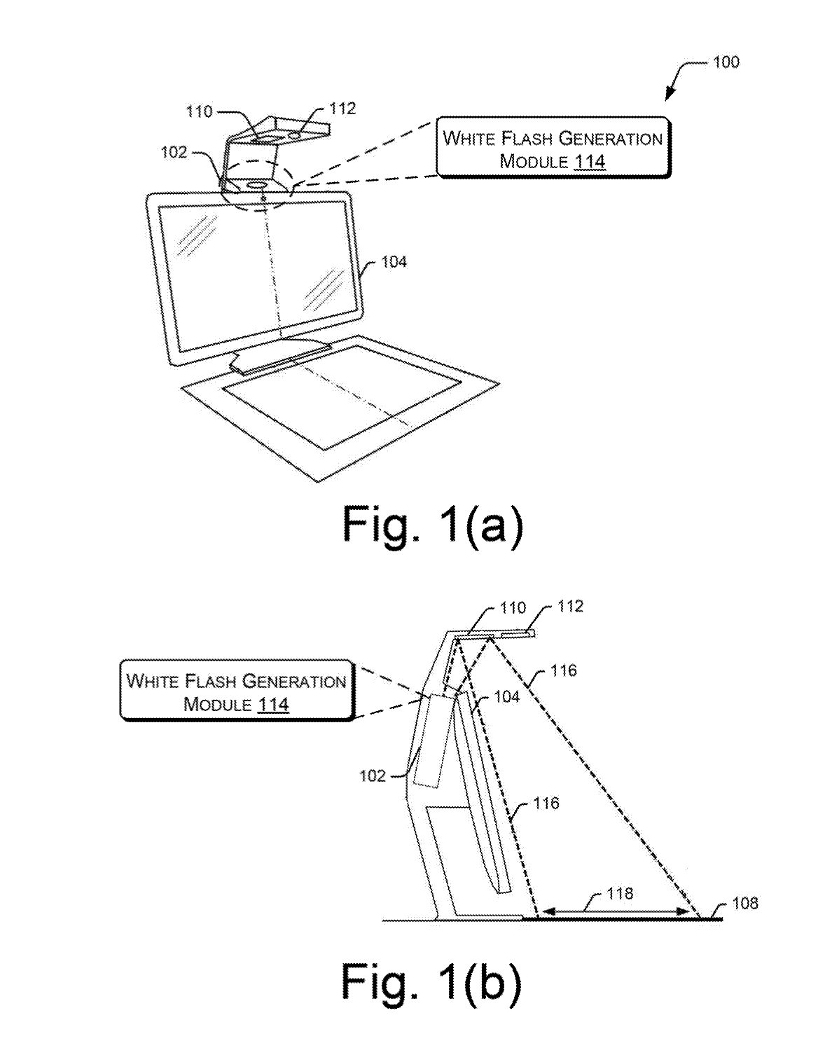

The above mentioned systems and methods are further described with reference to FIG. 1 to FIG. 4. It should be noted that the description and figures merely illustrate the principles of the present subject matter along with examples described herein and, should not be construed as a limitation to the present subject matter. It is thus understood that various arrangements may be devised that, although not explicitly described or shown herein, embody the principles of the present subject matter. Moreover, all statements herein reciting principles, aspects, and specific examples thereof, are intended to encompass equivalents thereof.

FIGS. 1(a) and 1(b) illustrates perspective views of a projection system 100 including an LED projector 102, according to an example of the present subject matter. For the sake of explanation, the description of FIG. 1(a) and FIG. 1(b) has provided been simultaneously. The projection system 100 may include a computing system 104 associated with the LED projector 102.

The computing system 104 may comprise any suitable computing system capable of implementing the principles disclosed herein. For instance, in some examples, the computing system 104 may comprise an electronic display, a Smartphone, a tablet, an all-in-one computer (i.e., a display that also houses the computer's board), or combinations thereof.

In FIGS. 1(a) and 1(b), the computing system 104 may be an all-in-one computer that includes a display to project images for viewing and interaction by a user (not shown). In some examples, the display of the computing system 104 may include touch sensitive displays, such as resistive displays, capacitive displays, acoustic wave displays, infrared (IR) displays, strain gauge displays, optical displays, acoustic pulse recognition displays, and combinations thereof. Therefore, throughout the following description, the display may periodically be referred to as a touch sensitive surface or touch display.

The LED projector 102 may be coupled with the computing system 104 such that the LED projector 102 may project data, such as images and videos onto a surface 108. In one example of the present subject matter, the LED projector 102 may be mounted behind the computing system 104. The LED projector 104 may be mounted either on the display of the computing system 104, or may be mounted behind the display through one or more supporting structures and fastening mechanisms (not shown), which may vary based on the configuration of the LED projector 102 and the place of mount on the computing system 104.

Although the LED projector 102 has been shown to be mounted behind the display of the computing system 104, it would be noted that the LED projector 102 may be coupled with the computing device 104 in other configurations as well.

The LED Projector 102 may comprise any suitable digital LED projector assembly for receiving data from a computing system, such as the computing system 104 and project an image or images onto the surface 108. The LED projector 102 may include compact and power efficient projection engines capable of multiple display resolutions and sizes, such as standard XGA (1024×768) resolution 4:3 aspect ratio or standard WXGA (1280×800) resolution 16:10 aspect ratio.

The LED projector 102 may further be communicatively coupled to the computing system 104 in order to receive data and generate light and images on the surface 108 during operation. The LED projector 102 may be communicatively coupled to the computing system 104 through any suitable coupling known. For example, in some implementations, the LED projector 102 may be communicatively coupled to the computing system 104 through an electric conductor, a WI-FI connection, a BLUETOOTH® connection, an optical connection, an ultrasonic connection, or any combination thereof. In an example of the present subject matter, the LED projector 102 may be electrically coupled to the computing system 104 through electrical leads or conductors that may be disposed within the computing system 104.

The surface 108 onto which the LED projector 102 may project images and data may either comprise of a passive projection surface, or may include an active projection surface, such as a touch sensitive surface. The passive projection surface may include, but not limited to, a high contrast grey projection surface, a matt white projection surface, an optical projection surface, a high gain projection surface, an acrylic projection surface, and an acoustically transparent projection surface.

In case the surface 108 is an active projection surface, such as the touch sensitive surface, it may allow detection and tracking of one or multiple touch inputs of a user in order to allow the user to interact with the computing system 104, or some other computing system (not shown). For example, in some implementations, the surface 108 may utilize touch sensitive technologies, like, resistive, capacitive, acoustic wave, infrared, strain gauge, optical, acoustic pulse recognition, or combinations thereof. In addition, it would be noted that the active projection surface may be communicatively coupled to the computing system 104 such that user inputs received by the surface 108 are communicated to the computing system 104. Any suitable wireless or wired coupling or connection may be used between the surface 108 and the computing system 104, such as WI-FI, BLUETOOTH®, ultrasonic, electrical cables, electrical leads, electrical spring-loaded pogo pins with magnetic holding force, or any combination thereof.

Although it has been shown that the LED projector 10 may project images and data onto a horizontal surface, such as the surface 108, it would be noted that the LED projector 102 may also project the images and data onto surfaces in other orientations as well, such as vertical surfaces and slanted surfaces.

Further, to project the images and data by the LED projector 102, the projection system 100 may further include a reflective surface 110. The reflective surface 110 may be positioned to reflect images and/or light projected by the LED projector 102 toward the surface 108 during operation. The reflective surface 110 may comprise any suitable type of mirror or reflective surface to reflect light for projection onto the surface 108. In an example, the reflective surface 110 may be a complex aspherical curvature to act as a reflective lens element to provide additional focusing power or optical correction to the LED projector 102.

In one example implementation of the present subject matter, the projection system 100 may also include an image capturing device 112, such as a camera to capture images and videos of objects placed on the surface 108. The projection system 100 may also include other sensors, such as proximity sensor, and light sensor, along with the image capturing device 112. However, such sensors have not been shown in the figure for the sake of brevity and ease of explanation.

The image capturing device 12 in examples of the present subject matter may comprise a camera which may be arranged to take either a still image or a video of an object and/or document disposed on the surface 108. The image capturing device 112 may also be a single infrared (IR) camera, or a dual IR camera for capturing images and videos in low light situations.

In operation, the LED projector 102 may generate and emit light that may be reflected off of the reflective surface 110 towards the surface 108, thereby displaying an image. The LED projector 102 may operate in different projection modes to project images videos and data onto the surface 108. Each projection mode may include different configuration of the LED projector to project light in a predetermined manner, onto the surface 108. For example, the LED projector 102 may include a presentation mode where the projection of images may be made in a standard XGA (1024×768) resolution with a 4:3 aspect ratio. Similarly, the LED projector 102 may also include a movie projection mode where the projection of videos may be made in a standard WXGA (1280×800) resolution with a 16:10 aspect ratio. In an example implementation of the present subject matter, the LED projector 102 may also generate white flash in a white-light mode of projection. To this end, the LED projector 102 may include a white flash generation module 114. The white flash generation module 114 may detect an input from the user to switch the LED from any one of the projection modes, to the white-light mode of projection. In the white-light mode, the white flash generation module 114 may actuate all the LEDs of the LED projector 102 simultaneously to generate a white flash.

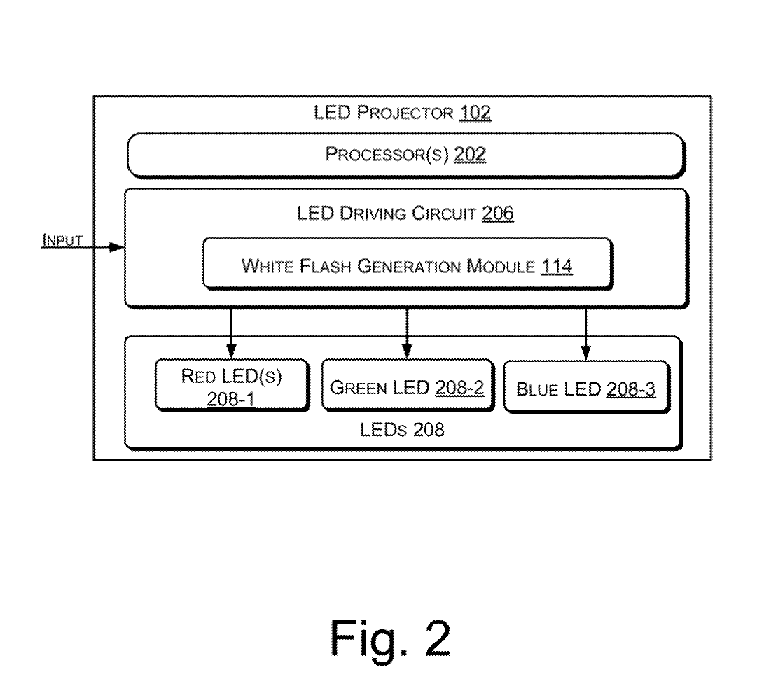

While referring to FIG. 1(b), in the white-light mode of projection, the LED projector 102 may generate white flash and emit white light 116 onto the surface 108. The generation of the white flash may illuminate section 118 of the surface 108. Accordingly, any article placed onto the surface 108 would be illuminated and correspondingly an artifact free image can be captured by the image capturing device 112. The description of the functioning of the LED projector 102 in the while-light mode of projection has been further explained in detail in reference to FIG. 2. Further, the components of the LED projector 102 to allow generation of the white flash are also further described in reference to FIG. 2.

FIG. 2 depicts the components of the LED projector 102 to generate white flash in a white-light mode. In one example implementation of the present subject matter, the LED projector 102 may include processor(s) 202. The processor(s) 202 may be implemented as microprocessor(s), microcomputer(s), microcontroller(s), digital signal processor(s), central processing unit(s), state machine(s), logic circuit(s), and/or any device(s) that manipulates signals based on operational instructions. Among other capabilities, the processor(s) 202 may fetch and execute computer-readable instructions stored in a memory.

The functions of the various elements shown in the figure, including any functional blocks labeled as “processor(s)”, may be provided through the use of dedicated hardware as well as hardware capable of executing machine readable instructions. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM) non-volatile storage.

The LED projector 102 may also include I/O interface(s) (not shown), for example, interfaces to connect to different devices, such as the computing system 104, other I/O devices, storage devices, and network devices. The interface(s) may include Universal Serial Bus (USB) ports, WI-FI ports, host bus adaptors, etc., and their corresponding device drivers. Accordingly, the interface(s) may facilitate the communication of data between the LED projector 102 and the other devices.

The LED projector 102 may further include a LED driving circuit 206 to control and drive one or more LEDs 208. The LEDs 208 may include one or more red LEDs 208-1 one or more green LEDs 208-2, and one or more blue LEDs 208-3. The LEDs 208 may include, but not limited to, miniature LEDs, such as single die LEDs, high power LEDs, and application specific LEDs (AS-LEDs). The LED driving circuit 206 may operate and control the LEDs 208 to project image and data onto the surface 108.

In one example implementation of the present subject matter, the LED projector 102 may generate white flash to generate instantaneous white light. The white flash generation module 114 may switch the LED projector 102 from any mode of projection to the white-light mode of projection. In the example implementation, the switching may be based on an input received by the LED projector 102.

The input may either be directly received from the user of the projection system 100 through a dedicated input switch, or may be received from the computing system 104 coupled with the LED projector 102. In operation, while the LED projector 102 is operating in any of the projection modes, the user may wish to capture an image of either the surface 108, or of an object placed on the surface 108. In such situations, the user may press the dedicated switch to provide the input to the LED projector 102.

In another example of the present subject matter, user may make a gesture which may be recognized by the computing system 104. The gesture may either be made on the surface 108 which may be a touch sensitive surface, or the gesture may be made anywhere within the section 118 for recognition by one or more sensors of the computing system 104. Based on identification of the gesture made by the user, the computing system 104 may generate the input to be provided to the LED projector 102.

Upon receiving the input, the white flash generation module 114 may switch the projection mode of the LED projector 102 to the white-light projection mode, such that the LED projector 102 may generate and emit instantaneous white light.

While the LED projector 102 is switched to the white-light mode of projection, the white flash generation module 114 may actuate all the LEDs 208, simultaneously. That is, the white flash generation module 114 may simultaneously provide driving signal to all the LEDs 208, including the one or more red LEDs 208-1, one or more green LEDs 208-1, and one or more blue LEDs 208-3. Based on the driving signal provided by the white flash generation module 114, all the LEDs 208 may instantaneously emit light to generate an instantaneous white light.

In one example of the present subject matter, the white flash generation module 114 may actuate the LEDs 208 for a predetermined time period. For instance, in an example, the white flash generation module 114 may actuate the LEDs 208 for the predetermined time period of 5 seconds. In another example, the white flash generation module 114 may actuate the LEDs 208 for the predetermined time period of 10 seconds. Therefore, the predetermined time period may vary from configuration to configuration and can be modified by the user of the projection system 100.

In another example implementation of the present subject matter, the white flash generation module 114 may generate strobes of white light during the white-light mode of projection. It would be noted that the strobes of white light may include light patterns where the LEDs 208 are in an ‘On’ state for a certain time period and are in an ‘Off’ state for another time period. For example, the white flash generation module 114 may generate a strobe of white light where the LEDs 208 are actuated and put in ‘On’ state for 3 seconds and thereafter are put in ‘Off’ state for 1 second. Such sequence of ‘On’ and ‘Off’ states of the LEDs 208 may be repeated by the white flash generation module 114 for the predetermined time period to generate the strobe of white light in the white-light mode of projection.

The time period of the ‘On’ state and the ‘Off’ state of the LEDs 208 may be identified by the white flash generation module 114 based on predefined strobe parameters. The predefined strobe parameters may define time periods of the ‘On’ state and ‘Off’ state of the LEDs 208, and may also define the predefined time period for which the pattern of ‘On’ state and ‘Off’ state may be carried out.

In one example of the present subject matter, the white flash generation module 114 may switch the LED projector 102 from the white-light mode of projection to its previous projection mode. The switching may either be initiated by the white flash generation module 114 after the expiry of the predetermined time period, or may be initiated by a trigger. In case the switching is initiate based on the predetermined time period, the white flash generation module 114 may monitor the time lapsed since the LED projector 102 was switched to the white-light mode of projection. Upon expiry of the predetermined time period, the white flash generation module 114 may switch the LED projector back to the previous projection mode.

For instance, if the LED projector 102 is operating in a first projection mode and the white flash generation module 114 has switched the LED projector 102 to the white-light mode of projection for the predetermined time period of 10 seconds, upon expiry of 10 seconds, the white flash generation module 114 may switch the LED projector 102 back to the first projection mode. As described earlier, it would be noted that the predetermined time period may either be hardwired into the white flash generation module 114, or may be configured by different users based on different configurations.

In one example implementation of the present subject matter, the white flash generation module 114 may also switch the LED projector 102 back to the earlier projection mode from the white-light mode of projection upon occurrence of a trigger. The trigger may either be an external input from the user of the projection system 100, or may be an occurrence of a preconfigured event.

The user may provide an input in different ways such as by press of a defined button, or by making a predefined gesture either in the section 118, or on the surface 108. For example, the user may double tab onto the surface 108 which may be a touch sensitive surface. Similarly, the user may wave in a predefined manner within the section 118 which may be analyzed by the sensors along with the image capturing device 112. As described earlier, the computing system 104 may receive such inputs from the user and may provide them to the white flash generation module 114 of the LED projector 102.

In some examples of the present subject matter, the white flash generation module 114 may switch the LED projector 102 back to the previous projection mode based on occurrence of the preconfigured event. The, preconfigured event include situations, such as completion of operation of the image capturing device 112, occurrence of a slide in a presentation being executed on the computing system 104 and being projected by the LED projector 102.

Accordingly, the white flash generation module 114 of the LED projector 102 may generate white flash of light and allow the image capturing device 112 to capture images and videos without any rainbow or gray scale artifacts.

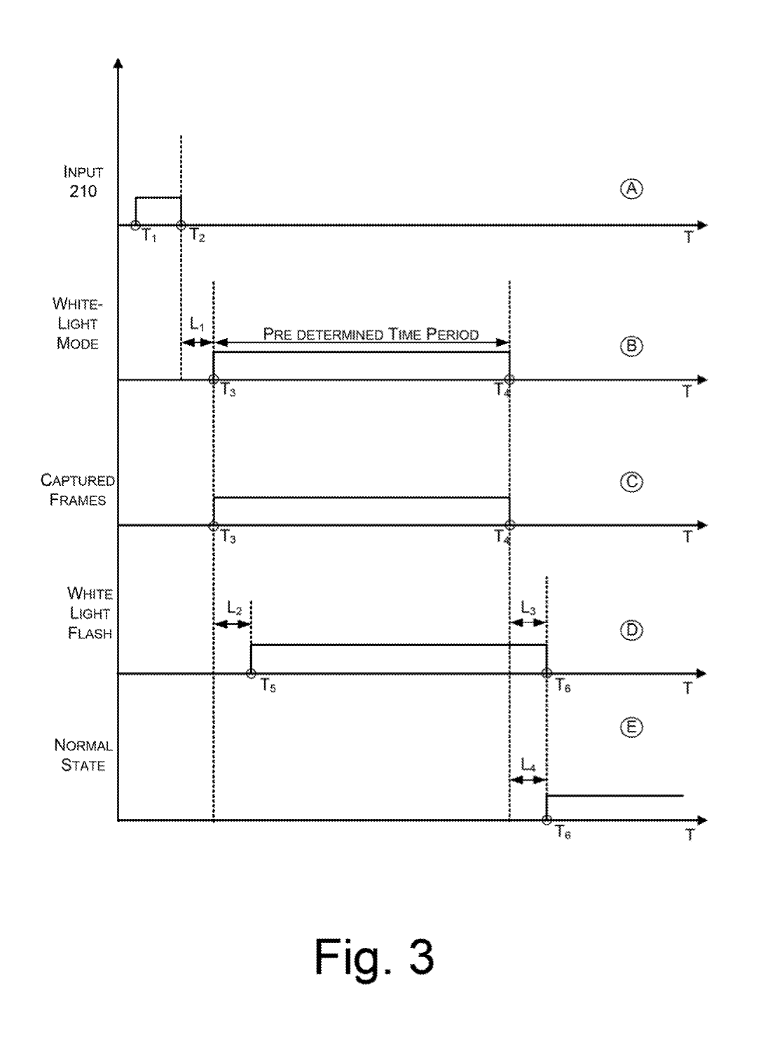

FIG. 3 graphically illustrates signal analysis of the LED projector 102 while operating in the white-light mode of projection, according to an example of the present subject matter. Different graphs including ‘A’, ‘B’, ‘C’, ‘D’, and ‘E’ represent different signals where the ‘X’ axis of the graphs represents time while the ‘y’ axis of the graphs represent amplitude of the represented signal. It would be appreciated that ‘y’ axis of the graphs may either represent voltage signals, or may represent current signals, depending upon the implementation of the LED projector 102.

Referring to graph ‘A’ in FIG. 3, the ‘X’ axis of the graph may represent the input signal. As described before, the input signal may either be directly received by the LED projector 102, or may be provided by the computing system 104. The input signal may be received at time instance T₁ and may extend up to time instance T₂. Although the signal has been shown to be a square wave, it would be noted that the signal may include rising and falling edges due to which some latency may be induced.

Upon receiving the input, the LED projector 102 may switch to the white-light mode of projection for generation of the white flash. Graph ‘B’ represents the white-light mode of projection for the LED projector 102. In one example, the white flash generation module 114 may switch the LED projector into the white-light mode of projection after time instance t₂. Considering some latency delay L₁, either due to falling edge of the input signal or due to communication delay in transmission, the switching to the white-light mode of projection may initiate at time instance T₃.

As described earlier, the white-light mode of projection may be switched back to the earlier projection mode by the white flash generation module 114, after a predetermined time period. In one example, the LED projector 102 may remain in the white-light mode of projection up to time instance T₄ and may then be switched to an earlier projection mode. Accordingly, the white-light mode may terminate after the predetermined time period at time instance T₄.

As would be noted, the time duration during which the image capturing device 112 may capture images or video may be the predetermined time period during which LED projector 102 is in the white-light mode of projection. Accordingly, in said example and as depicted in graph ‘C’, the image capturing device 112 may capture images or video for the predetermined time period between T₃ and T₄.

In the white light of projection, the white flash generation module 114 may actuate all the LEDs 208. Graph ‘D’ represents a LED actuation signal provided by the white flash generation module 114 to all the LEDs 208. In one example, the white flash generation module 114 may send the signal to actuate all the LEDs 208 after time instance T₃. Considering some latency delay L₂, either due to delay in detection of the rising edge of the white-light mode signal, the signal to actuate the LEDs 208 may be initiated at time instance T₅. Upon identifying the switching of the LED projector 102 from the white-light mode to other projection mode at time instance T₄, the white light flash may be stopped. Due to some delay in detecting the signals and due to other communication delays, the white flash may stop at time instance T₆, after a latency delay L₃ from the time instance T₄.

Once the LED projector 102 is successfully switched from white-light mode of projection to other projection mode, the LED projector 102 may again operate as it was operating in its previous projection mode. As discussed above, the normal state may be regained by the LED projector 102 after a delay latency of L₄ due to delay in detecting the signals, or due to other communication delays.

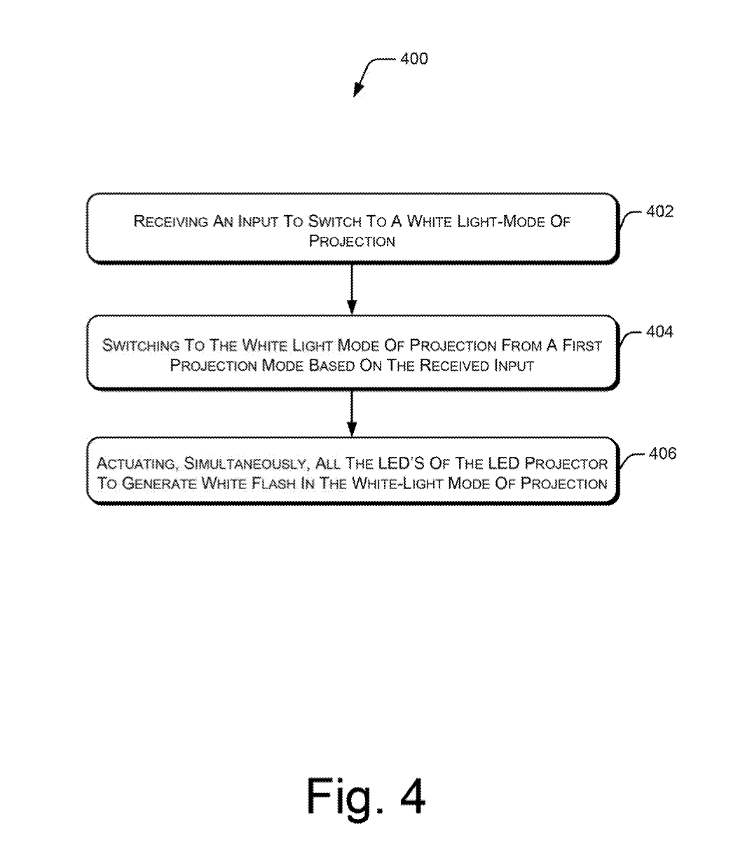

FIG. 4 illustrates a method 400 for generating white flash from a LED projector coupled with a computing system, according to an example of the present subject matter. The order in which the method 400 is described is not intended to be construed as a limitation, and any number of the described method blocks may be combined in any order to implement the method 400, or an alternative method. Furthermore, the method 400 may be implemented by the LED projector 102 through any suitable hardware components, non-transitory machine readable instructions, or combination thereof.

It may be understood that steps of the method 400 may be performed by programmed LED projector. The steps of the method 400 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media.

Further, although the method 400 may be implemented in a variety of projection systems; in an example described in FIG. 4, the method 400 is explained in context of the aforementioned projection system 100.

Referring to FIG. 4, in an example of the present subject matter, at block 402, an input may be received to switch the LED projector to a white-light mode of projection. In one example implementation, the input may either be a direct user input, received directly from the user through a press of a button, or may be an indirect input, indirectly received through a computing system. In situations where the input is received through the computing system, the computing system may first receive the input from the user through one or different input devices, such as touch surface; and may provide it to the LED projector.

At block 404, the LED projector may be switched to a white-light mode of projection, in response to the received input. In one example of the present subject matter, the LED projector may be switched from a first projection mode to the white-light mode of projection to generate white flash of light. In one example, an image capturing device of the computing system may also be actuated in the white-light mode of projection to capture images or video of objects placed on projection surface of the LED projector.

At block 406, the LEDs of the LED projector may be simultaneously actuated to generate a white flash. It would be noted that the LED projector may include red, green, and blue LEDs. The actuation of all the LEDs simultaneously may generate instantaneous white light in the white-light mode of projection.

The generation of white flash may project an instantaneous white light onto the projection surface such that the image capturing device may capture images free from any rainbow or gray scale artifacts.

Although implementations of present subject matter have been described in language specific to structural features and/or methods, it is to be understood that the present subject matter is not necessarily limited to the specific features or methods described. Rather, the specific features and methods are disclosed and explained in the context of a few example implementations for projection systems.

What is claimed is:

1. A method for generating white flash from a Light Emitting Diode (LED) projector coupled to a computing system, the method comprising:
receiving an input to switch projection mode of the LED projector to a white-light mode of projection, wherein the input is one of a direct user input and an indirect input;
switching the LED projector to the white-light mode of projection from a first projection mode based on the received input, wherein the LED projector operates on one or more projection modes; and
actuating, simultaneously, all LEDs of the LED projector to generate a white flash of light in the white-light mode of projection.

2. The method as claimed in claim 1, wherein the method further comprises switching the LED projector back to the first projection mode from the white-light mode of projection, after a predetermined time period.

3. The method as claimed in claim 1, wherein the method further comprises switching the LED projector back to the first projection mode from the white-light mode of projection, based on occurrence of a trigger.

4. The method as claimed in claim 1, wherein the indirect input is received through the computing system, and wherein the computing system receives the indirect input through a touch gesture made by the user on a projection surface of the LED projector.

5. The method as claimed in claim 1, wherein the white flash of light is generated in a pattern to form strobes of white light, wherein the pattern is based on predefined strobe parameters.

6. The method as claimed in claim 1, wherein the all LEDs of the LED projector includes at least one red LED, at least one green LED, and at least one blue LED.

7. A projection system for generation of white flash from a LED projector, the projection system comprising:
a computing system;
the LED projector coupled to the computing system comprising a white flash generation module to:
receive an input from the computing device to switch projection mode of the LED projector to a white-light mode of projection;
switch the LED projector to the white-light mode of projection from a first projection mode based on the received input, wherein the LED projector operates on a plurality of projection modes;
actuate, simultaneously, at least one red LED, at least one green LED, and at least one blue LED from amongst all LEDs of the LED projector to generate a white flash of light in the white-light mode of projection; and
switch the LED projector back to the first projection mode from the white-light mode of projection, based on occurrence of a trigger.

8. The projection system as claimed in claim 7, wherein actuation of the at least one red LED, the at least one green LED, and the at least one blue LED from amongst all the LEDs is to generate an increased illuminance of projected light by the LED projector.

9. The projection system as claimed in claim 7 further comprising an image capturing device coupled to the computing system to capture images during the white-light mode of projection.

10. The projection system as claimed in claim 7 further comprising a projection surface to project light emitted by the LED projector, wherein the projection surface is one of a passive projection surface and an active projection surface to receive the input.

11. The projection system as claimed in claim 7, wherein the trigger is an external input from the user.

12. A LED projector coupled to a computing system for generation of white flash, the LED projector comprising:
at least one red LED;
at least one green LED;
at least one blue LED;
a LED driving circuit coupled to the at least one red LED, the at least one green LED, and the at least one blue LED, comprising a white flash generation module to:
identify the LED projector to be operating in white-light mode of projection; and
actuate simultaneously, at least one red LED, at least one green LED, and at least one blue LED from amongst all LEDs of the LED projector to generate a white flash of light in the white-light mode of projection.

13. The LED projector as claimed in claim 12, wherein the white flash generation module further switches the LED projector to a first projection mode from the white-light mode of projection.

14. The LED projector as claimed in claim 13, wherein the switching is based on a predefined time period.

15. The LED projector as claimed in claim 12, wherein the white flash generation module actuates the at least one red LED, the at least one green LED, and the at least one blue LED in a pattern to generate strobe of white light, and wherein the pattern is based on predefined strobe parameters.
